(19) United States
(12) Patent Application Publication
(10) Pub. No.: US 2006/0119901 A1
(43) Pub. Date: Jun. 8, 2006

(54) Handheld text scanner

(76) Inventors: Feri Ehrenfeld, Mazkeret Batya (IL); Boris Gutin, Jerusalem (IL)

Correspondence Address: DANIEL J SWIRSKY, 55 REUVEN ST., BEIT SHEMESH, 99544, IL

(21) Appl. No.: 11/003,495

(22) Filed: Dec. 6, 2004

(51) Int. Cl. H04N 1/04

(52) U.S. Cl. 358/474

(57) ABSTRACT

A portable text scanner includes a text scanning element to scan text, a touch screen and an editor to enable a user to edit the scanned text. A portable note taker includes the text scanning element, the touch screen and an editor at least to receive the scanned text and to receive new text through the touch screen to be added to the scanned text.

### FIELD OF THE INVENTION

The present invention relates to handheld text scanners.

### BACKGROUND OF THE INVENTION

Handheld text scanners are known in the field. Some exemplary scanners, which are marketed under the names QUICKTIONARY, QUICKLINK-PEN, SUPERPEN, INFOSCAN, and READINGPEN, are commercially available from Wizcom Technologies Ltd., the common assignee of the present invention.

When a user drags a handheld text scanner over printed text, such as that in a book or newspaper, the scanner scans the text, performs optical character recognition and displays the result. Typically, the scanner may read printed text that is between 6 and 22 points and of a standard font.

Some of the scanners audibly pronounce the scanned text. Others translate the scanned text and still others provide dictionary services for the scanned text such as definition, synonyms, antonyms, thesaurus, etc.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic illustration of a handheld text scanner with a touch screen, constructed and operative in accordance with the present invention;

FIG. 2 is a block diagram illustration of elements of the text scanner of FIG. 1;

FIGS. 3A and 3B are schematic illustrations of an incorrectly scanned word and its correction, respectively, useful in understanding the operation of the scanner of FIG. 1;

FIGS. 4A and 4B are schematic illustrations of an empty note and an edited note, respectively, useful in understanding the operation of the scanner of FIG. 1; and

FIGS. 5A and 5B are schematic illustration of text added to scanned text, useful in understanding the operation of the scanner of FIG. 1.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Applicants have realized that handheld text scanners may make scanning mistakes, and as a result, the desired text may be incorrectly translated or pronounced. Additionally, circumstances may exist where it may not be possible to scan the text, as in the case where the text is not of a standard font, nor of the preferred text size of 6 to 22 points, or may not even be typed text at all. Prior art handheld text scanners allow a user to enter text by scanning in bar codes associated with each alphanumeric character. This method is awkward. Applicants have realized that a handheld text scanner that may receive text via a method other than scanning may be beneficial.

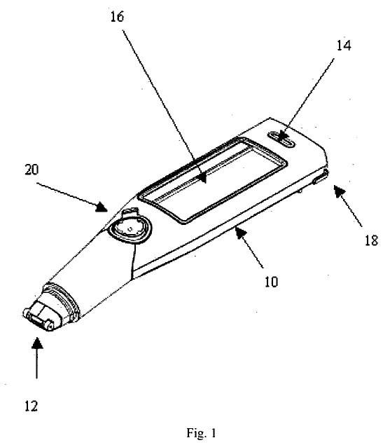

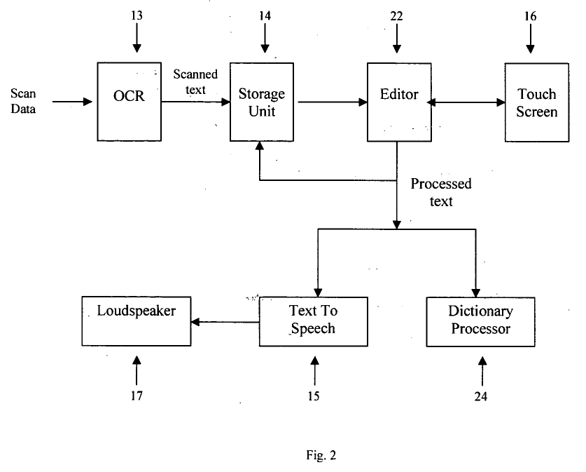

Reference is now made to FIGS. 1 and 2, which illustrate a handheld text scanner 10, constructed and operative in accordance with the present invention. FIG. 1 is an isometric view and FIG. 2 illustrates the logical elements of the scanner of FIG. 1.

Like other handheld text scanners, handheld text scanner 10 may comprise an optical head 12 to optically scan text, an optical character recognition unit 13 to convert the scan data to scanned text and a storage unit 14 at least to store the scanned text. In accordance with a preferred embodiment of the present invention, scanner 10 may additionally comprise an editing system which may comprise a touch screen 16, a stylus 18, a control button 20 and an editor 22 (FIG. 2), to enter and edit text on touch screen 16. Scanner 10 may also comprise other text processors, such as a dictionary processor 24 to provide dictionary services, such as translation, definition, thesaurus, etc., given an input text and/or a text-to-speech unit 15 to convert the scanned text to an audio signal with a loudspeaker 17 to audibly pronounce selected text.

A user may hold scanner 10 generally perpendicular to a piece of text, such as a book or magazine. The user may move scanner 10, and particularly optical head 12, along the text. The scanned text will be displayed in touch screen 16. The user may review the text and, if necessary, such as when the scanned text is incorrect, may edit it in editor 22 using stylus 18.

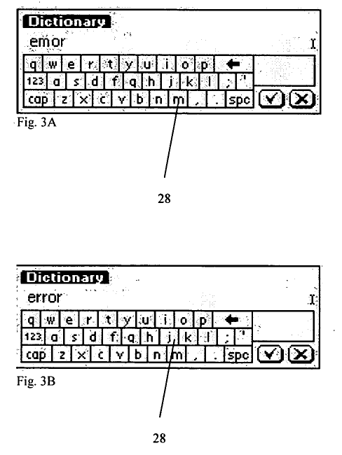

For example, FIGS. 3A and 3B to which reference is now briefly made, may illustrate the operation of editor 22. FIG. 3A shows a scanned text, the word “emor” and FIG. 3B shows the corrected version, the word “error”.

As can be seen in FIG. 3, editor 22 may display a virtual keyboard 28 in touch screen 16 and the user may select an alphanumeric character to press on the displayed keyboard. The selected character may then be used to edit the text. In FIGS. 3A and 3B, the word “emor” has been corrected to “error”.

Editor 22 may then provide the edited text to dictionary processor 24 which may, in turn, process the text in the desired way. For example, dictionary processor 24 may translate the text, may provide a definition or may provide other dictionary services as available for the edited text. Dictionary processor 24 may be any suitable dictionary processor, such as the one available in the QUICKTIONARY scanner. The output of dictionary processor 24 may be displayed in touch screen 16.

Alternatively, if text is not able to be scanned, for example if the user would like to handle text on a billboard or poster, or the text is handwritten, the user may enter the text through editor 22 and touch screen 16. The entered text may then be handled in the same manner as edited text.

The scanned and/or edited and/or entered text may be provided to text-to-speech unit 15 whose output may be provided to loudspeaker 14 for audible pronunciation. Text-to-speech unit 15 may read the word aloud, may pronounce the word letter-by-letter, and/or may read aloud dictionary definitions for the word.

Alternatively or in addition, the scanned and/or edited and/or entered text may be stored in storage unit 14.

It will be appreciated that the present invention may provide a portable reader, translator or dictionary with little or no limitations on text. Text is not required to be of any specific font or size. It is not even required to scan text, as text may be entered using the touch screen. This allows text to be corrected, so that if the user notices a scanning mistake, the user may fix the mistake before the mistake affects the translation process.

Scanner 10 may be utilized for dictionary services, as described hereinabove. It may also be utilized in other ways as well, such as to scan text into a computer or other devices like a personal digital assistant (PDA) or a cellphone. In this mode, the user may scan the text, edit any scanning errors, with editor 22, and may store the word or words. At some appropriate time, the user may upload the scanned text to a computer, such as a personal computer or other devices like a PDA or a cellphone.

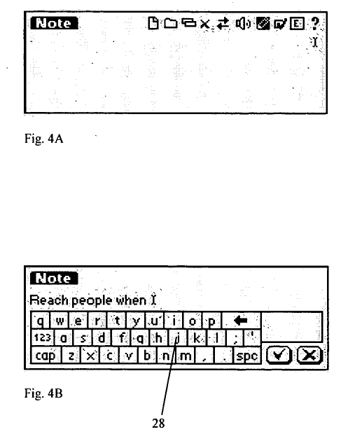

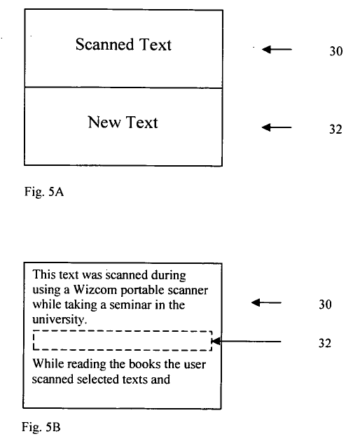

Scanner 10 may form part of a portable note-taker. In this embodiment, the user may want to enter text, as shown in FIGS. 4A and 4B, to which reference is now made, or comment on a piece of printed text, as shown in FIGS. 5A and 5B, to which reference is now made. FIG. 4A shows a blank note and FIG. 4B shows a note that a user may have entered into editor 22 with virtual keyboard 28.

Alternatively, as shown in FIG. 5, the user may scan a desired text 30, which may be stored in storage unit 14. The user may then review text 30 in editor 22 and may add new text 32, using virtual keyboard 28, into scanned text 30. The edited document may then be stored in storage unit 14.

As shown in FIG. 5, the user may add new text 32 in any suitable location. FIG. 5A shows new text 32 after scanned text 30 and FIG. 5B shows new text 32 within scanned text 30. Other locations for new text 32 are also possible and are included in the present invention.

For handheld scanners 10 that have applications and settings menus, touch screen 16 may also provide menu services to the user. Using stylus 18, the user may select a mode from a menu of possible modes.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A portable text scanner comprising:
a text scanning element to scan text; and
a touch screen;
an editor in communication with said touch screen to enable a user to edit said scanned text.

2. The scanner according to claim 1 and wherein said editor comprises virtual keyboard means to display a keyboard and to receive key presses from said touch screen.

3. The scanner according to claim 1 and also comprising a text processor to communicate with said editor.

4. The scanner according to claim 3 and wherein said text processor comprises at least one of the following text processors: a dictionary processor, a text-to-speech unit and means for providing said text externally at a later time.

5. The scanner according to claim 4 and wherein said dictionary processor provides at least one of the following services: translation, definition and thesaurus.

6. The scanner according to claim 4 and wherein said text-to-speech unit comprises means for pronouncing a word letter-by-letter and means for reading a word's definition.

7. A portable dictionary comprising:
a handheld text scanning element to scan text;
a touch screen;
an editor in communication with said touch screen to enable a user to edit said scanned text; and
a dictionary processor to provide dictionary services for text received from said editor.

8. The dictionary according to claim 7 and wherein said dictionary processor provides at least one of the following services: translation, definition and thesaurus.

9. The dictionary according to claim 7 and also comprising means for providing said text externally at a later time.

10. The dictionary according to claim 7 and wherein said editor comprises virtual keyboard means to display a keyboard and to receive key presses from said touch screen.

11. A portable note taker comprising:
a handheld text scanning element to scan text;
a touch screen;
an editor at least to receive said scanned text and to receive new text through said touch screen to be added to said scanned text.

12. The note-taker according to claim 11 and also comprising means for providing said new text externally at a later time.

13. The note-taker according to claim 11 and wherein said editor comprises virtual keyboard means to display a keyboard and to receive key presses from said touch screen.
